(19) United States
(12) Patent Application Publication
(10) Pub. No.: US 2024/0068264 A1
(43) Pub. Date: Feb. 29, 2024

(54) Telescopic Equipment Hanging Device For Portable Shelters And Ground Blinds

(71) Applicant: Bram Owen Olson, Waldorf, MN (US)

(72) Inventor: Bram Owen Olson, Waldorf, MN (US)

(21) Appl. No.: 17/893,179

(22) Filed: Aug. 23, 2022

(51) Int. Cl. E04H 15/44; A01M 31/02

(52) U.S. Cl. CPC E04H 15/44; A01M 31/025

(57) ABSTRACT

The invention is a new and innovative way to hang, suspend or otherwise secure equipment inside a hub-style ground blind or hub-style portable shelter. The invention features the new system of utilizing telescopic components to span the distance between hub-style portable shelter and ground blind ceiling hub poles, as well as hub-style portable shelter and ground blind side wall hub poles. This new system allows the user to adjust the overall spanning length of the invention, allowing it to be installed at varying distances between two adjacent ceiling hub or side wall hub poles. The invention features custom hooks that mechanically secure to the telescopic components, which are then hooked over two adjacent hub poles, but under the hub fabric. Custom hooks are attached to the invention in between the ends and can be used to hang equipment in varying locations along the telescopic components.

### CROSS-REFERENCE TO RELATED APPLICATIONS

Provisional Patent mailed Jun. 2, 2022

### STATEMENT REGARDING FEDERALLY SPONSORED RESEARCH OR DEVELOPMENT (IF APPLICABLE)

Not Applicable

### REFERENCE TO SEQUENCE LISTING, A TABLE, OR A COMPUTER PROGRAM LISTING COMPACT DISC APPENDIX (IF APPLICABLE)

Not Applicable

### BACKGROUND OF THE INVENTION

This invention is directed to those personnel who utilize a hub-style ground blind, or utilize a hub-style portable shelter. I started bowhunting turkey from a ground blind seven years ago and quickly learned that bowhunting from a hub-style ground blind is challenging but a bigger challenge had been finding a suitable way to secure my compound bow while hunting. Current products do not allow the user to secure, hang or otherwise suspend the compound bow in my preferred location, which would be to have the bow suspended between the ground blind ceiling hub and the ends of two adjacent ceiling hub poles that extend and separate with distance out toward the ground blind ceiling corners. I needed to find a way to hang the bow out in front of me, at an arm's length right where I wanted it to be to facilitate the execution of a shot.

I made a prototype using a wooden dowel and some screw hooks from Menards which were screwed into the ends of the 36″ long, 1″ diameter dowel. I drilled a hole in the middle of the dowel and put a ¼″ J-hook to hold my bow while turkey hunting. It worked well enough for 4 years, but had room for improvement. I started brainstorming on how to make it better, and decided to create a product to try to help others out who bow hunt from a ground blind.

The invention resolves the mentioned issues, allowing hub-style ground blind users to hang, secure or otherwise suspend equipment from between two adjacent ground blind ceiling hub poles, and allow the freedom to secure, hang or otherwise suspend equipment laterally from various locations along the span of the invention itself. This device, I quickly realized, can also be applied to hub-style portable shelter use as well (i.e. portable hub-style fishing hub). The invention can be utilized on hub-style portable shelter ceiling hub poles and side wall hub poles to hang equipment. There is now an improved solution to securing, hanging, or otherwise suspending equipment in a hub-style ground blind or hub-style portable shelter.

### BRIEF SUMMARY OF THE INVENTION

Finding a suitable and convenient avenue to support a compound bow while hunting from a hub-style ground blind has been a challenge for many bowhunters who hunt from a ground blind. Existing products do not allow to ability to suspend a compound bow at varying locations between adjacent ground blind ceiling hub poles. The positional adjustability of the invention allows the user to suspend equipment from the ceiling hub out toward the ends of two adjacent ceiling hub poles. The invention allows the user to hang, suspend or otherwise secure a compound bow in between the ceiling hub itself and two adjacent ceiling hub pole ends. The invention is the solution to this common issue.

The invention is applicable to equipment, in general, not just a means to suspend a compound bow. The invention can be used on hub-style ground blind ceiling hub poles and side wall hub poles in order to hang or otherwise suspend equipment. The invention can also be used on hub-style portable shelter ceiling hub poles and side wall hub poles. The invention features telescopic components which provide the adjustable spanning capability of the device. These telescopic components have holes drilled through them from which custom hooks are tightened with threaded nuts and thumb nuts. See FIG. 12/13 for an illustration. Hooks are installed at each end of the telescopic components, and then can be slid over ground blind ceiling hub poles. Equipment hooks are installed within the interior of the device from which equipment can be hung, secured or otherwise supported. The invention utilizes the strength of the hub-style ground blind hub poles or hub-style portable shelter hub poles, in particular the ceiling hub poles, in order to suspend equipment.

### BRIEF DESCRIPTION OF THE SEVERAL VIEWS OF THE DRAWINGS

Drawing 1/8 consists of FIG. 1, FIG. 2, FIG. 3 and FIG. 4.

FIG. 1 is the Side view of the longer of the two telescopic components

FIG. 2 is the Top view of the longer of the two telescopic components

FIG. 3 is the Side view of the shorter of the two telescopic components

FIG. 4 is the Top view of the shorter of the two telescopic components

Drawing 2 consists of FIG. 5 and FIG. 6.

FIG. 5 is the Side view of the left side hanging hook

FIG. 6 is the Rear view of the left side hanging hook

Drawing 3 consists of FIG. 7 and FIG. 8.

FIG. 7 is the Side view of the right side hanging hook

FIG. 8 is the Front view of the right side hanging hook

Drawing 4 consists of FIG. 9 and FIG. 10.

FIG. 9 is the Side view of the compound bow hanging hook

FIG. 10 is the Side view of the quick hanging hook

Drawing 5 consists of FIG. 11

FIG. 11 is the Side view of the general equipment hanging hook

Drawing 6 consists of FIG. 12

FIG. 12 illustrates some main features, applications, and components of the invention

Drawing 7 consists of FIG. 13 and FIG. 14

FIG. 13 illustrates a sample assembly and shows multiple applications of the invention.

FIG. 13 also identifies online retail sourced parts of the assembly, as well as illustrating some adjustability features of the invention

FIG. 14 illustrates the separation capability of the invention. The telescopic components can be completely separated and utilized individually as part of equipment hanging devices for hub-style ground blinds and hub-style portable shelters

Drawing 8 consists of FIG. 15

FIG. 15 is an illustration to further depict the application and adjustability of the invention as an equipment hanging device for hub-style ground blinds and hub-style portable shelters.

### DETAILED DESCRIPTION OF THE INVENTION

The invention is an equipment hanging device for hub-style portable shelters and hub-style ground blinds. It is the first invention designed to be adjustable in length in order to span varying distances between ground blind ceiling hub poles or portable shelter ceiling hub poles from which to hang equipment. The invention is similar to a shower curtain rod, but it has hooks that secure to it from which an individual can hang, suspend or otherwise secure equipment. In addition, the invention features hooks at the far ends which are placed over the hub ceiling poles, but under the hub exterior fabric itself. Hence, the invention is suspended from adjacent hub-style ground blind ceiling hub poles or adjacent hub-style portable shelter ceiling hub poles. The invention can also be used between two adjacent hub-style portable shelter side wall hub poles, or hub-style ground blind side wall hub poles.

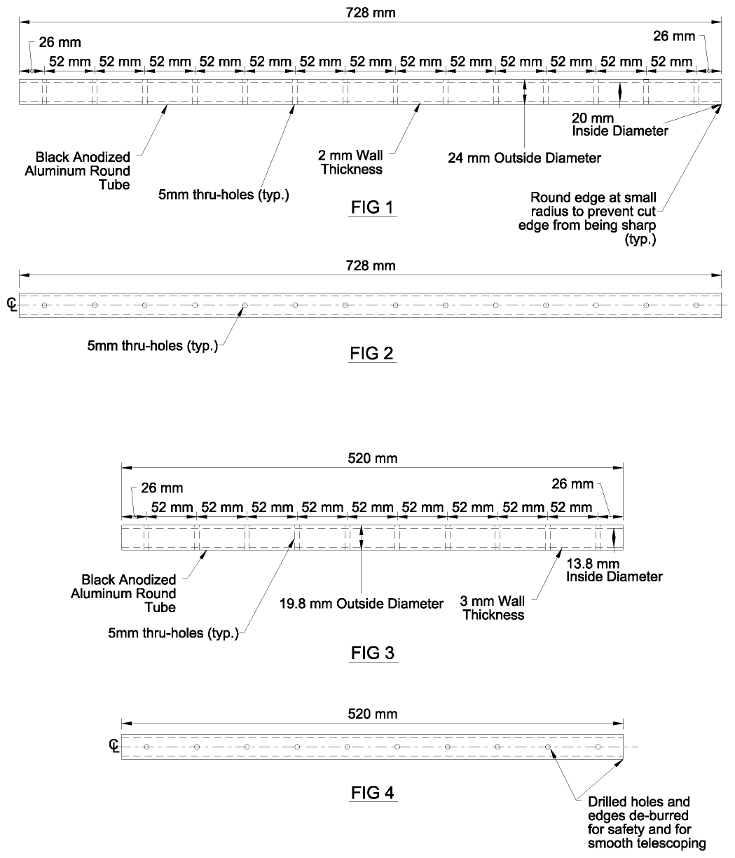

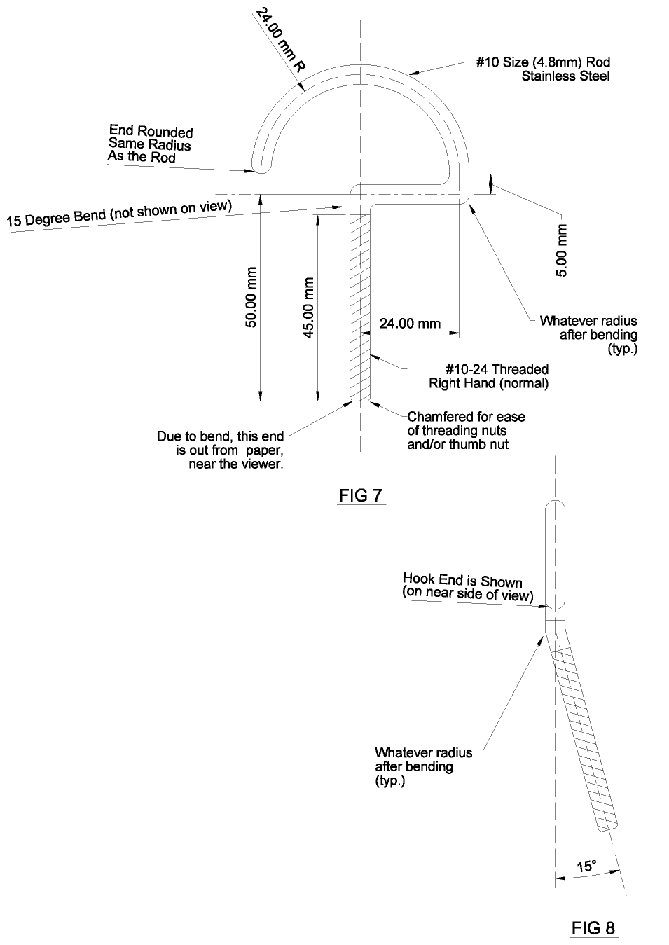

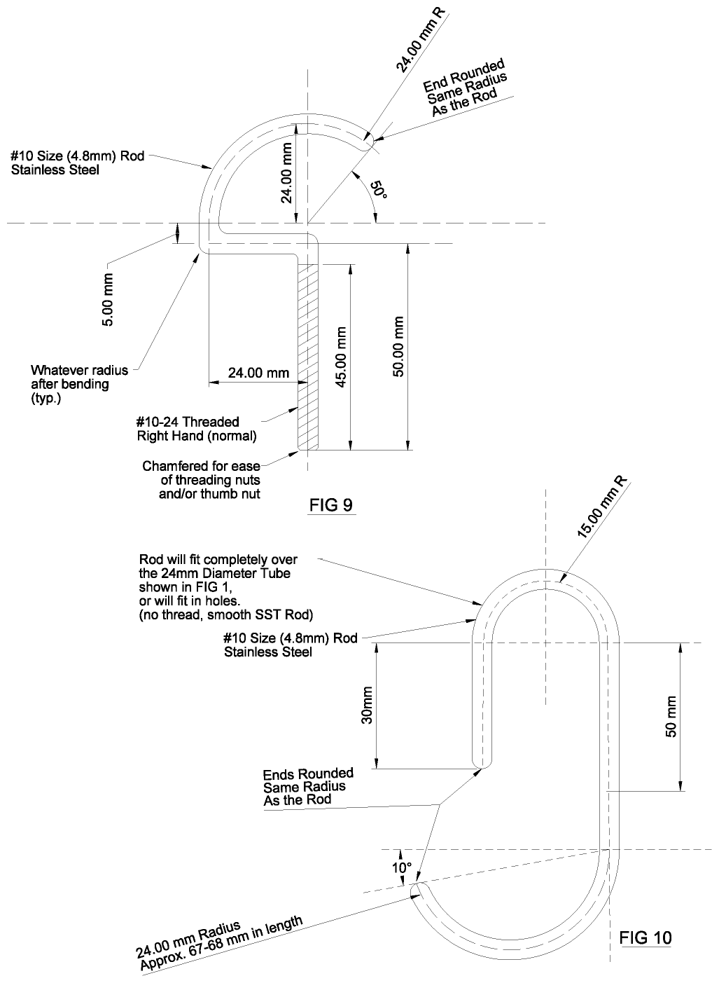

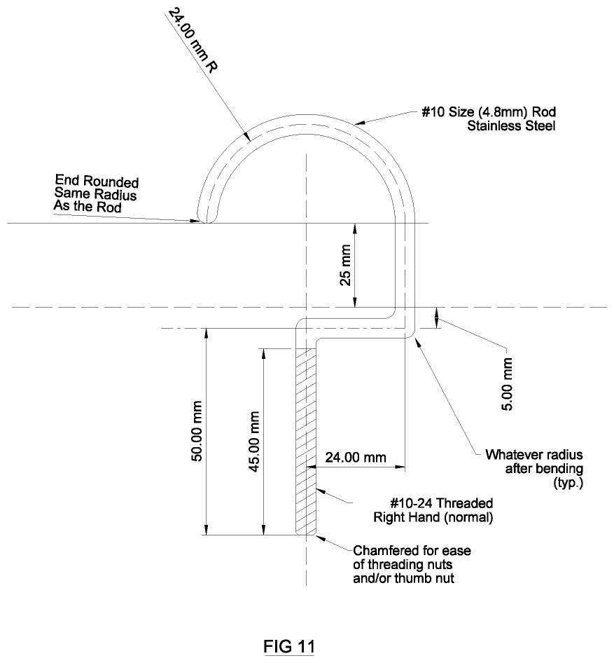

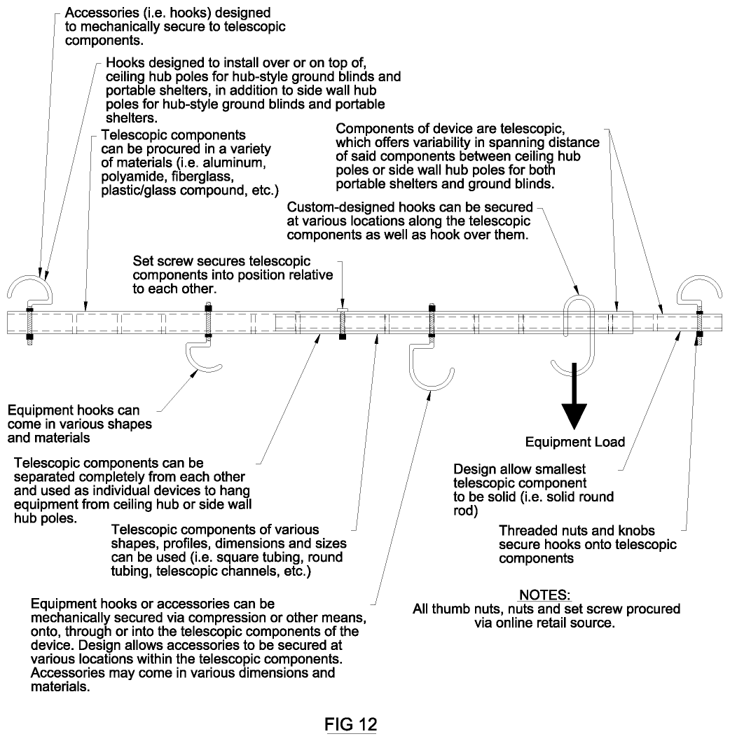

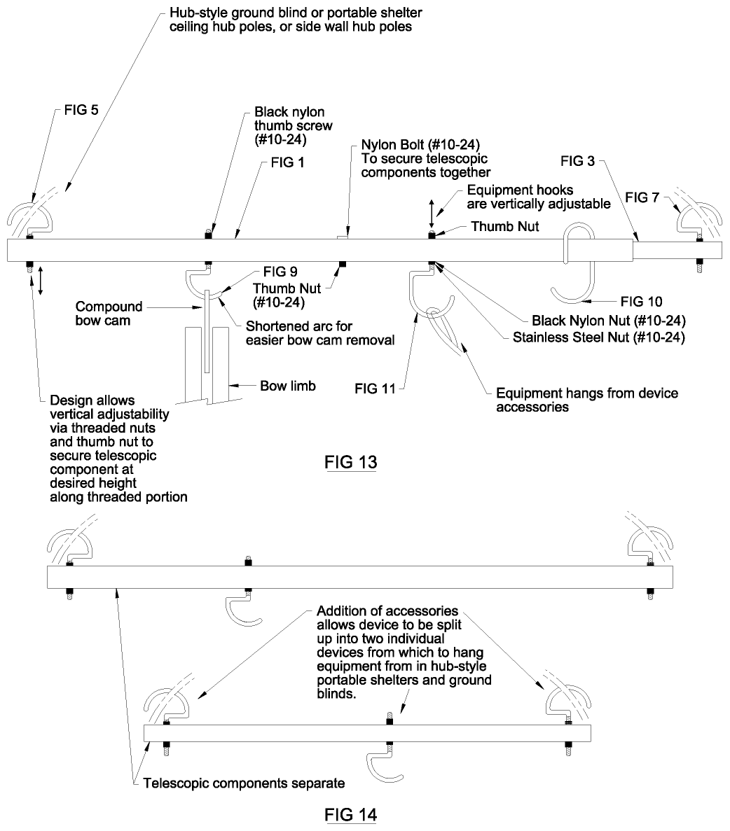

The invention is comprised, in part, of two telescopic tubes that have holes drilled through them both, evenly spaced apart. See FIG. 1/2 & FIG. 3/4 for the schematic and details. These tubes are telescopic, so one of them can slide in and out of the other one. This makes the invention linearly adjustable. The holes that are drilled through the tubes are spaced evenly so they can line up, and custom-made hooks can be inserted through the tube holes. See FIG. 5/6, FIG. 7/8, FIG. 9, FIG. 10 and FIG. 11 for examples. The user can secure the telescopic tubes in relationship to each other with a nylon bolt and thumb nut, or utilizing one of the custom equipment hanging hooks (see FIG. 12). These holes feature a threaded portion to which threaded nuts can be installed and secure the telescopic tubes. See FIG. 12 and FIG. 13 for an illustration. The invention is held in place by end hooks (See FIG. 5/6 and FIG. 7/8) which are secured at each extremity end of each telescopic component (when in a telescoping position), and slid over the ground blind ceiling hub poles from the inside of the ground blind. Due to the design of the invention, the telescopic tubes are supported/suspended by the hub ceiling poles or hub side wall poles. The nylon bolt keeps the overlapping telescopic components in place in relationship to each other, or an equipment hook can serve the same purpose.

The invention is designed to physically separate the telescopic components from each other. Each component can be fitted with appropriate end hooks and equipment hooks to serve as individual equipment hanging devices for hub-style ground blinds and hub-style portable shelters.

The invention allows for countless uses and applications when it comes to hanging equipment from hub-style ground blind hub poles and hub-style portable shelter hub poles.

### How to Make the Invention

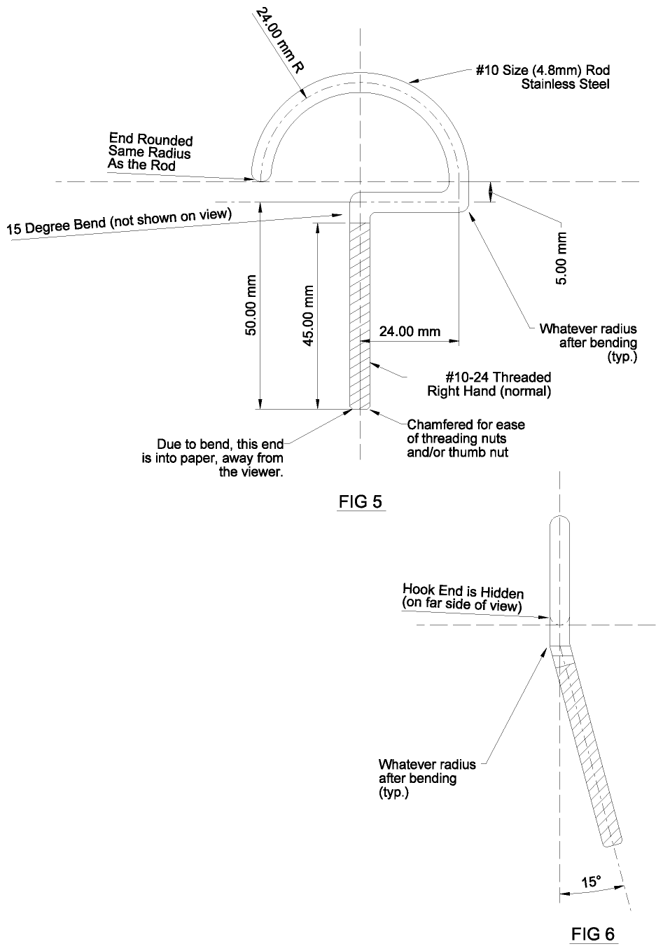

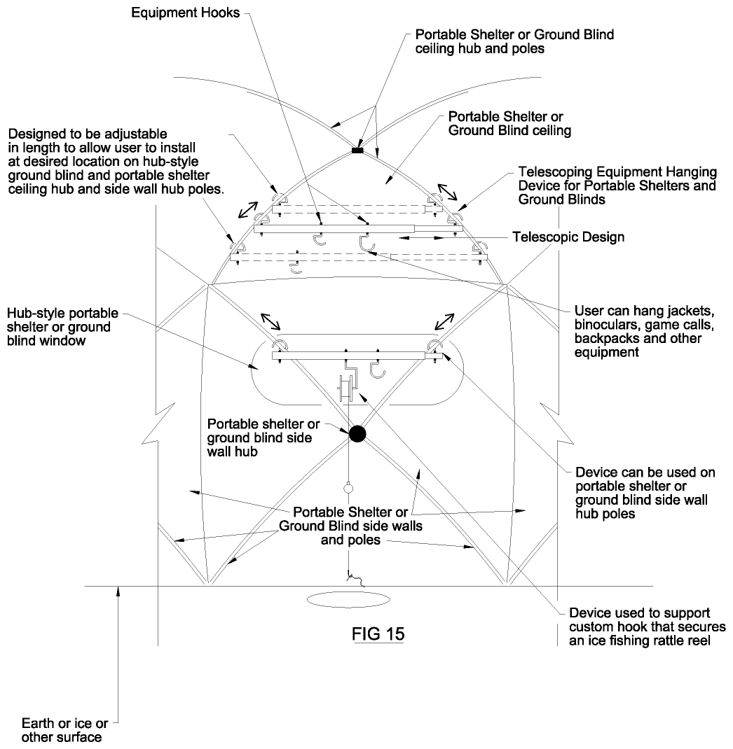

1.) Procure FIG. 1/FIG. 2 from a CNC fabrication source
2.) Procure FIG. 3/FIG. 4 from a CNC fabrication source
3.) Procure FIG. 5/FIG. 6 from a CNC fabrication source
4.) Procure FIG. 7/FIG. 8 from a CNC fabrication source
5.) Procure FIG. 9 from a CNC fabrication source
6.) Procure FIG. 10 from a CNC fabrication source
7.) Procure FIG. 11 from a CNC fabrication source
8.) Procure (#10-24) nylon nuts from online retail source
9.) Procure (#10-24) nylon thumb nuts from online retail source
10.) Procure (#10-24) stainless steel nuts
11.) Procure (#10-24) nylon threaded bolts from online retail source
12.) Assemble device as per FIG. 13 or as desired
13.) See FIG. 14 for alternate application
14.) See FIG. 15 for additional usage capabilities

1. A device for hub-style portable shelters and hub-style ground blinds comprised, in part, of telescopic components designed to span the distance between adjacent portable shelter or ground blind ceiling hub poles as well as adjacent portable shelter or ground blind side wall hub poles, from which equipment can be hung, secured, or otherwise supported

2. An equipment hanging device for hub-style portable shelters and ground blinds comprised, in part, of telescopic components capable of separation from each other allowing each component to then be utilized individually as part of an equipment hanging device for hub-style portable shelters and ground blinds

3. An equipment hanging device for hub-style portable shelters that supports, in part or entirely, a fishing line rattle reel or supporting component thereof
